(19) United States
(12) Patent Application Publication
(10) Pub. No.: US 2007/0179903 A1
(43) Pub. Date: Aug. 2, 2007

(54) Identity theft mitigation

(75) Inventors: Marc Seinfeld, Kenmore, WA (US); Carl Ellison, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/342,447

(22) Filed: Jan. 30, 2006

(51) Int. Cl. H04L 9/00

(52) U.S. Cl. 705/67

(57) ABSTRACT

Public-key authentication, based on public key cryptographic techniques, is utilized to authenticate a person opening an account. The person provides a declaration to use only public-key authentication and a copy of his/her public key to an authorized agent, such as a credit bureau. The person provides a signed request to open an account with a merchant based on public-key authentication. This merchant requests a credit report from the credit bureau, providing the credit bureau the applicant's public key. The credit bureau uses the public key to locate a credit report. Barring theft of the user's private key, the credit report will be that of the requesting user with a high probability. The credit bureau can then provide the requested information to the merchant, and the merchant can provide notification to the person that the account is authorized or not, based on what the merchant reads in the credit report.

### TECHNICAL FIELD

The technical field generally relates to identification theft, and more specifically relates to alternatives to “fact based authentication.”

### BACKGROUND

Identity theft is becoming more prevalent. Many types of identity theft are a result of an unauthorized person (an imposter) using facts about another person to open or access an account in the legitimate person's name. Typically, facts include personally identifying information such as a social security number, a mother's maiden name, an address, a zip code, an employer's name, a driver's license number, or the like. The imposter need only show knowledge of the facts in order to access or open an account. Knowledge of enough facts will authorize the imposter to access and/or open an account. This process can be called “fact based authentication.” Attempts to prevent identity theft have focused on keeping such facts secret.

A problem with attempting to prevent identity theft by keeping personally identifying information secret is that the identifying information is not secret and never will be, because it is known by other than the parties trying to use it for the purpose of authentication. Also, personally identifying information is typically obtainable through a variety of channels. Thus an unscrupulous imposter could obtain a person's identifying information without the person's knowledge.

### SUMMARY

This Summary is provided to introduce a selection of concepts in a simplified form that are further described below in the Detailed Description Of The Illustrative Embodiments. This Summary is not intended to identify key features or essential features of the claimed subject matter, nor is it intended to be used to limit the scope of the claimed subject matter.

Public-key authentication, as described herein, mitigates identity theft. Rather than determining authentication on knowledge of facts such as personally identifying information (e.g., social security number, social security number, mother's maiden name, address, zip code, employer's name, driver's license number, bank account numbers), a public-key authentication system determines authentication based on knowledge of the private key of a public key-private key cryptographic key pair. Public-key authentication helps ensure that an imposter can not open and/or access an account using another person's identity because, in part, it is an authentication mechanism in which the secret stays with the originator.

The following introduces an exemplary embodiment that consists of a process with two parts: (1) registration of the end user with a central repository of credit information that would be consulted by any institution offering an end user credit and (2) opening of an account by the end user with such an institution. Each of those two parts has two options described below: (1a) in which the end user has no prior credit history and therefore is a new person from the point of view of the credit information repository, (1b) in which the end user does have a prior credit history and needs to authenticate himself or herself to the credit information repository in order to change an existing relationship to one that rejects fact based authentication, (2a) in which the end user creates an account with a lending institution that has installed the software and modified its business processes to be part of the public-key authentication system for account creation, and (2b) in which the end user creates an account with a lending institution that has not installed that software and still relies on legacy, fact-based authentication. Option (2b) also covers the case of the end user, having switched to public-key authenticated account opening, verifies that accounts opened with fact-based authentication prior to that switch are in fact valid and will be honored by the end user.

In case (1a) of the exemplary embodiment, for a person having no previous credit history, the person first declares to one or more central repositories, such as credit bureaus, that he/she has no credit history and intends to reject the use of “fact based authentication” in all his or her account creations. The person also creates a key pair in accordance with well known public key cryptographic techniques. The person keeps the private key secret and never needs to reveal the private key. The person provides the declaration and the public key to another entity such as a credit bureau, for example. The person then registers to open an account with each of those central repositories. To register, the person generates a digital request to open a new database entry. The request is signed by the person's private key, and delivered to the entity maintaining the database (e.g., a credit bureau). Because the person registering has no previous credit history, there is no need to tie the current registration to any previous history and therefore no need to prove the person's identity to the satisfaction of the holder of that credit history. The only personally identifying information communicated in this registration will be for the purpose of satisfying regulatory requirements rather than for authentication. The request is authenticated by the public key signature. In response to this request, the person gets a new database entry with that repository and this entry can be referenced by any bank or merchant with whom that person may later want to create a charge account, get a loan, receive a credit card, etc. The database entries for an individual are similar to current credit history database entries with the exception that the individual's public key is also recorded. In addition, the database entry contains a field held secret (communicated only with the individual) which is a fully random, high entropy password that will be used if the individual's key pair gets lost, destroyed or stolen and the individual needs to register a new public key.

When the individual chooses to open an account with some merchant or bank or credit-card issuer (called the lender, below)—that is some entity to which the individual will become indebted and therefore some entity where an identity thief might open an account that victimizes the individual—that entity will naturally ask for the applicant's credit history (database entry). On receiving this credit report, the lender will see the normal credit report information but also a notice that the individual refuses to accept liability for any account opened by way of “fact-based authentication” (with specific exceptions noted in the report). Instead, the individual chooses to open new accounts via public-key authenticated transactions, online. The credit report can also list the individual's public key (or a cryptographic hash thereof). In an exemplary embodiment, regardless as to whether the human-readable credit report lists the individual's public key, an online version available from the entity keeping the individual's database entry will include the public key.

Once an individual has chosen to use public-key authentication for opening accounts with lenders, there are two options: (2a) opening that account online, e.g., via a web service, or (2b) opening the account via traditional pen and paper applications.

In case (2a), the individual runs an application (or web browser) on his or her computer, fills out the application for the new account and digitally signs the application (or client-authenticates an SSL connection via the web browser), thus proving possession of the individual's private key. The lender receives this application, confers with the credit reporting service, discovers that the public key used by the applicant is in fact the public key of that registered individual and therefore has high assurance that the applicant is the registered individual and not an identity thief.

In case (2b), the lender does not offer the web service or web site capable of accepting public-key authenticated online applications. The applicant must therefore fill out a paper form, using standard Personally Identifiable Information (PII). If the lender were to take that form and consult a credit reporting service about that individual, the lender would see the notice that the identified individual rejects new accounts created in this way—with only those exceptions listed. If the applicant in this case is an identity thief, his or her intentions will be frustrated. If the applicant in this case is the actual individual, that individual will first have contacted the credit reporting services online, authenticated by public-key authentication and added a note to his or her database record that he or she intends to create an account with lender X within date and time window Y (some predetermined amount of time) in legacy PII style. Alternatively, the individual can start the application process with the lender, get an account number from the lender, and then tell the lender to hold off completing the application process until the applicant can connect to the credit reporting service and specifically exempt that new account—listing it by account number and the name of the lender. Once the applicant has modified his or her database entry to include that notice, using public-key authenticated transaction with the credit reporting service(s), the applicant can optionally contact the lender and tell it to proceed with fetching the credit report. In that report, the lender will see itself listed as an exception to the rule rejecting fact-based account openings.

For a person desiring to switch to public-key authentication but having an existing credit history that was based on fact based authentication, the process (case (1b)) is more detailed as described below. The person will still create a key pair and register it with the credit reporting agencies, but will need to prove his or her identity strongly enough to both convince the reporting agency that this person is the one referred to in the existing database entry and to discourage the identity thief strongly enough to reduce the problem of identity theft to an infrequent problem rather than the epidemic problem that it is today.

### BRIEF DESCRIPTION OF THE DRAWINGS

The foregoing summary, as well as the following detailed description, is better understood when read in conjunction with the appended drawings. For the purpose of illustrating identity theft mitigation, there is shown in the drawings exemplary constructions thereof, however, mitigating identity theft is not limited to the specific methods and instrumentalities disclosed. In the drawings:

FIG. 1 is a flow diagram depicting an exemplary sequence of events for using public-key authentication for opening accounts;

FIG. 2 is a flow diagram of an exemplary process for using public-key authentication for a new account from the user's perspective;

FIG. 3 is a flow diagram of the process for a user with an existing credit history who wants to switch to public-key authentication for all new accounts;

FIG. 4 is a flow diagram of an exemplary process for replacing a lost or stolen public key with a new one;

FIG. 5 is a depiction of an exemplary public-key authentication system; and

FIG. 6 is a diagram of an exemplary processor for implementing public-key authentication.

### DETAILED DESCRIPTION OF ILLUSTRATIVE EMBODIMENTS

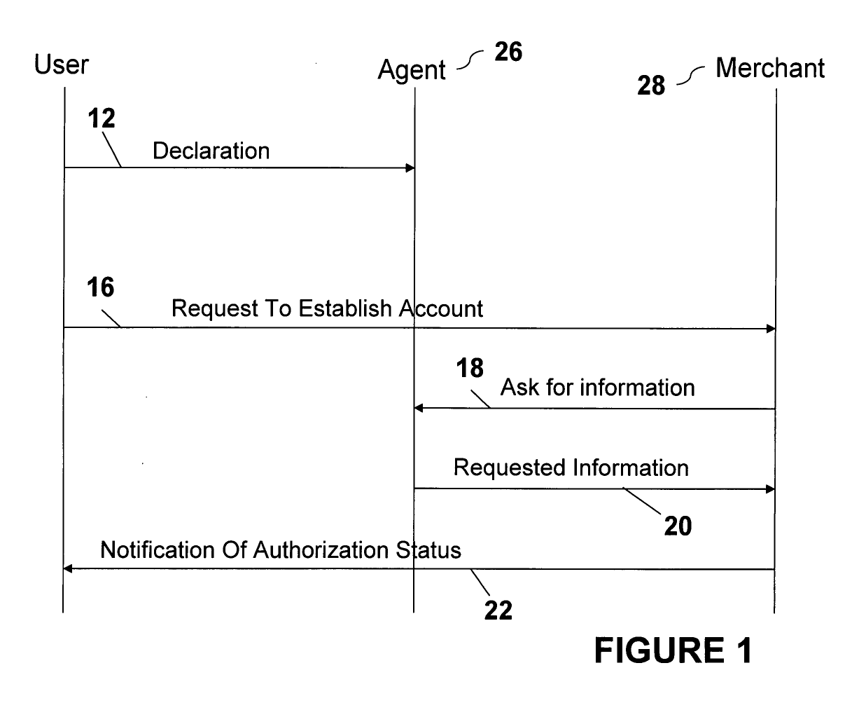

FIG. 1 is a flow diagram depicting an exemplary sequence of events for using public-key authentication for an individual with no credit history. The user generates a pair of cryptographic keys in accordance with well know public key cryptographic techniques. Public-key cryptography uses a pair of keys. One key is used to encrypt and the other is used to decrypt. Knowledge of the public key does not provide knowledge of the private key. The private key is kept secret but the public key can be widely disseminated without loss of security. At step 12, a user provides a declaration (digitally signed with the user's private key) noting his or her intention to start a credit history and to use public-key authentication for all account creations, rejecting liability for any accounts created in the traditional way, except as noted specifically. The user can provide the declaration to any appropriate entity 26, such as a credit bureau(s) or authorized agent(s) of the user, for example.

A standard part of any digitally signed message is the public key used to verify that signature. After step 12 the agent 26 has the user's declaration to use public-key authentication for account creation and has the user's public key. The declaration can also include a disclaimer that the user will accept no liability for accounts opened via a fact based authentication system.

The user requests to establish an account with a merchant (or lender) at step 16. The request can be provided to any appropriate entity 28, such as a merchant (e.g., credit card company, bank, retail store, investment firm, automobile dealership, or the like), for example. That is, the user could provide the public key to the entity with which the user intends to open the account. For example, the user can send the declaration and public key to well known credit bureaus (e.g., entities 26), and establish accounts with as many merchants (e.g., entities 28), as the user wishes to conduct business. The consumer will have registered with all the credit bureaus and a note can be entered in the user's credit report to the effect that: “no one may open an account for me using personally identifying information to authenticate me. The only acceptable authentication for opening new accounts is the public key provided herein.” That public key can be recorded in a database maintained by the credit bureau and a hash of the public key can be listed on the printed credit report. Hash functions are well known (e.g., MD5 and SHA-1). A hash function computes a fixed-length output from an input of any size with the characteristic that it is computationally infeasible to find any other input that would produce the same output as an existing input. Thus, a hash of the user's public key is a unique identifier of the public key, without using the space of a full public key.

In an exemplary embodiment, the request to establish an account includes information needed by the merchant to establish the account and is signed by the user's private key. Since the merchant is using on-line account creation authenticated by public-key, it is aware that applicants have adopted public-key account creation and eschewed traditional fact-based account creation. For verification of that, if the merchant is interested, the credit report on the applicant can contain that notice.

The merchant 28 verifies the request at step 18. In an exemplary embodiment, the merchant 28 requests a credit report for the user from the credit bureau 26, indicating the user by the user's public key (or hash thereof). The credit bureau 26 uses the user's public key to index the user's database entry. At step 20, the credit bureau 26 sends to the merchant 28 the credit report for the user who possesses the private key corresponding to the public key (or hash) that the merchant provided.

Upon receiving the requested information, the merchant 28 can determine whether to open an account for the user. The merchant 28 provides the notification of authorization status—that the account has been opened, or the account has been denied, at step 22. For example, the user could be legitimate but the user's credit report indicates that the user presents a high risk. Accordingly, the merchant 28 could deny the user's request to open the account.

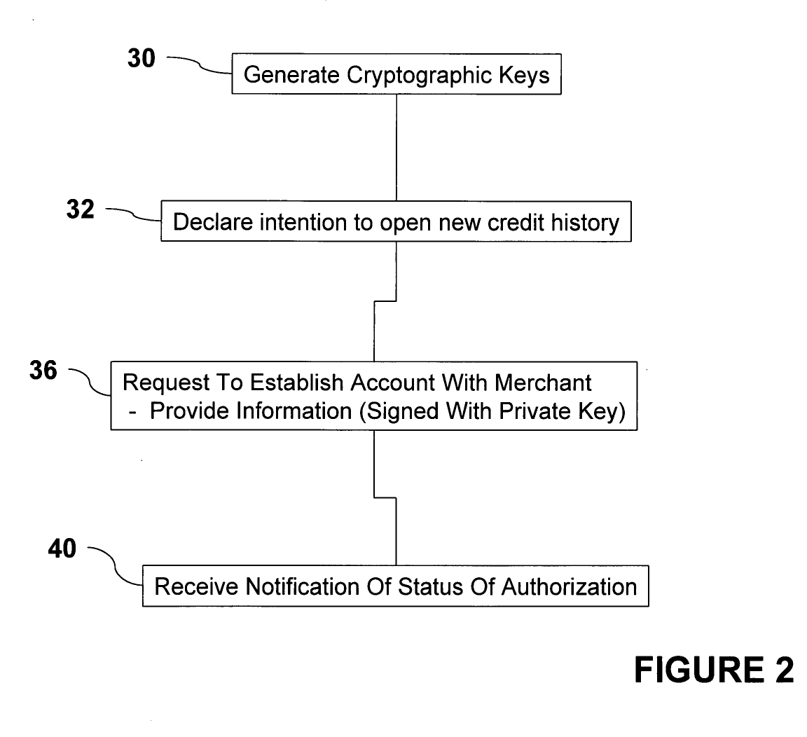

FIG. 2 is a flow diagram of an exemplary process for using public-key authentication for the first account from the perspective of a user with no prior credit history. At step 30, the user generates a key pair for use in this process (and optionally backs up that key pair carefully, so that it is not lost). At step 32, the user declares the intention to start a credit history and use only public-key authentication in opening accounts. In response to this creation of a new credit history, the user can receive from each credit bureau or other agent a secret password that is to be used if the user ever needs to replace the registered public key. The passwords from all such credit bureaus or other agents are securely backed up so that (1) the user is always able to get to one copy of those passwords and (2) no potential identity thief can get to any copy. Any appropriate means of backup and recovery can be utilized.

The user requests to establish an account with an entity, such as a merchant at step 36. As described above, the request includes signed information needed by the merchant to open the account and the public key of the user needed by the merchant to verify the signature on the request. At step 40, the user receives notification of the status of the authorization of the account (e.g., request to open account granted or request to open account denied).

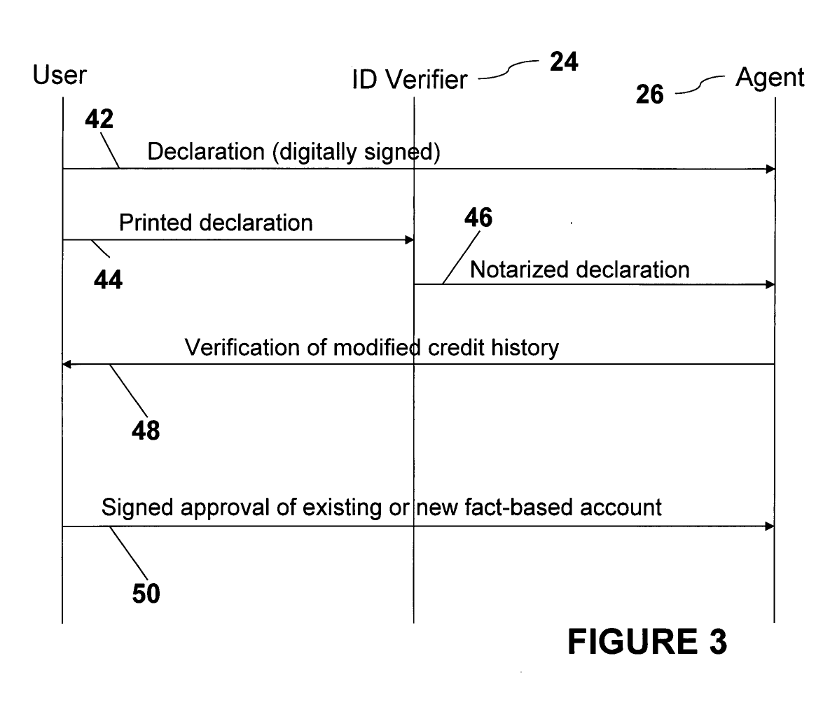

In an exemplary embodiment, if the user has an existing credit history, the process depicted in FIG. 1 is not used. That process would give the identity thief a relative easy way to steal someone's good credit history and establish liability for the victim. For users with existing credit histories or for other cases where a new user must be securely authenticated in traditional ways (e.g., if laws were to require that everyone with a credit report be identified by address or other PII), the process depicted in FIG. 3 is utilized. The user declares (at step 42) the intention to use public-key authentication for all new accounts. This declaration process is similar to the declaration process described with respect to step 12 of FIG. 1. Because the change in this credit record requires personal authentication as well, that request is not considered complete until after step 46. To finish this process, the user's computer prints a form that includes the user's public key (or hash thereof) and the traditional PII used to identify the user (and to authenticate him or her, under fact-based authentication). The user takes this form to an entity that is capable of verifying personal identity (such as a bank or a post office), at step 44. At that entity, the user's identity is verified. The identity verification entity can also create an audit record of this event, augmented by a picture of the user, fingerprints taken from the user, etc.

Once the ID verifier 24 is satisfied that the user's identity is as indicated on the printed form, the user signs that form in the presence of the ID verifier. The ID verifier 24 can notarize the form and will sign it, attesting to the user's identity. The ID verifier then transmits the paper form (e.g., by mail) to the agent (or credit bureau) 26. On receipt of this verification of physical identity, the agent (or credit bureau) can match that user with that person's credit history and match the reported public key of the physically verified user to the one that signed the original request for change and then effect the requested change. Once the account has been changed, the user is notified digitally of the change at step 48. During that transaction, the user will receive and properly backup the secret password(s) of the credit bureaus or agents involved, for later use in replacing the user's public key. At the successful completion of this change in status of the user's credit history, the user may be prompted to specifically approve all existing accounts or may voluntarily specify one or more existing or new accounts to specifically approve (step 50). This is the way a user can approve with public-key authentication an account that was created before the user switched to public-key authentication or that was created after the switch but with a merchant that is not yet capable of using public-key authentication for account creation.

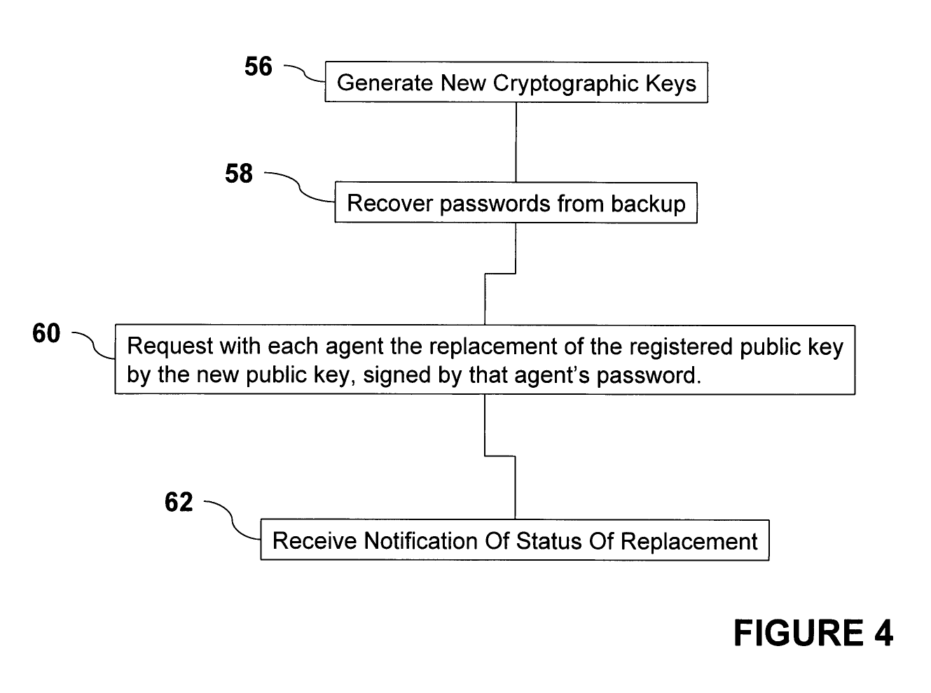

FIG. 4 depicts the process by which a user replaces a registered public key at the agent or credit bureau 26, in the event that the registered public key is lost or stolen. A loss could occur if the user's computer is destroyed or malfunctions, if the computer's hard drive is erased, or for a variety of other reasons. A theft of private key could occur if the key is held insecurely and the theft would be discovered via successful account creation by the thief. This account would need to be erased and the stolen private key erased and replaced. At step 56, the user generates a new key pair to replace the lost or compromised one. At step 58, the user recovers the secret, high-entropy passwords from backup storage that the credit bureaus or other agents had returned to the user in response to account creation. At step 60, the user's computer connects to each agent and sends a public-key change message, including the old public key as an identifier and the new public key. The message is signed by a standard symmetric-key signature algorithm (e.g., SHA1-HMAC) using the high entropy password as the key. In response to each such message, the agent returns a response indicating whether the request succeeded or failed. A request could fail, for example, due to improper message format, contents, or signature.

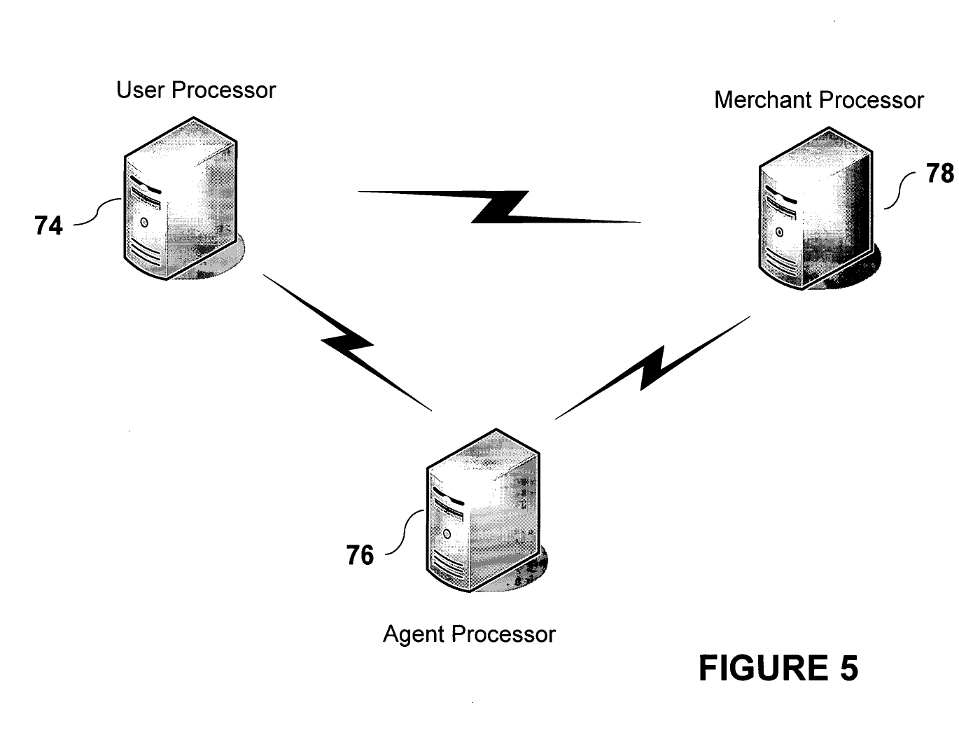

FIG. 5 is a depiction of an exemplary system using public key authentication to achieve account creation. The system comprises a user processor 74, an agent processor 76, and a merchant processor 78. Each of the processor 74, 76, and 78 can comprise any appropriate processor. Appropriate exemplary processors include general purpose processors, dedicated processors, desktop computers, laptop computers, Personal Digital Assistants (PDAs), handheld computers, smart phones, server processors, client processors, or a combination thereof. Each of the processors 74, 76, and 78, can be implemented in a single processor, such as a computer, or multiple processors. Multiple processors can be distributed or centrally located. Multiple processors can communicate wirelessly, via hard wire, or a combination thereof. Each portion of each processor 74, 76, and 78, can be implemented via multiple distributed processors, nodes and/or databases. The interfaces used by the processors 74, 76, and 78 to communicate to communicate therebetween, can comprise any appropriate interface, such a wireless interface, a wired interface, or a combination thereof. Any of a wide variety of communications protocols can be utilized, including both public and proprietary protocols. Examples protocols include TCP/IP, IPX/SPX, and NetBEUI. Communications between the processors 74, 76, and 78 can be via a network or networks. Each network can include a wired network or a direct-wired connection. Networks can comprise public portions (e.g., the Internet) as well as private portions (e.g., a residential Local Area Network (LAN)), or a combination thereof. Networks can be implemented using any one or more of a wide variety of conventional communications media including both wired and wireless media such as acoustic, RF, infrared and other wireless media.

In an exemplary embodiment, each of the user processor 74, the agent processor 76, and the merchant 78 is utilized to performed the above described functions associated with the user, the agent, and the merchant, respectively. For example, the user processor 74 would generate the pair of cryptographic keys. The user processor 74 would provide the public key to the appropriate entity (or entities). The user processor 74 would send a request to establish an account with an entity. The user processor 74 would send a disclaimer that the user will accept no liability for any transactions on an account opened based on fact based authentication. And the user processor 74 would receive notification of the status of the authorization of the account. Also, in accordance with the above description, the agent processor 76 and the merchant processor 78 can be part of a single entity, and in an exemplary embodiment comprise a single processor.

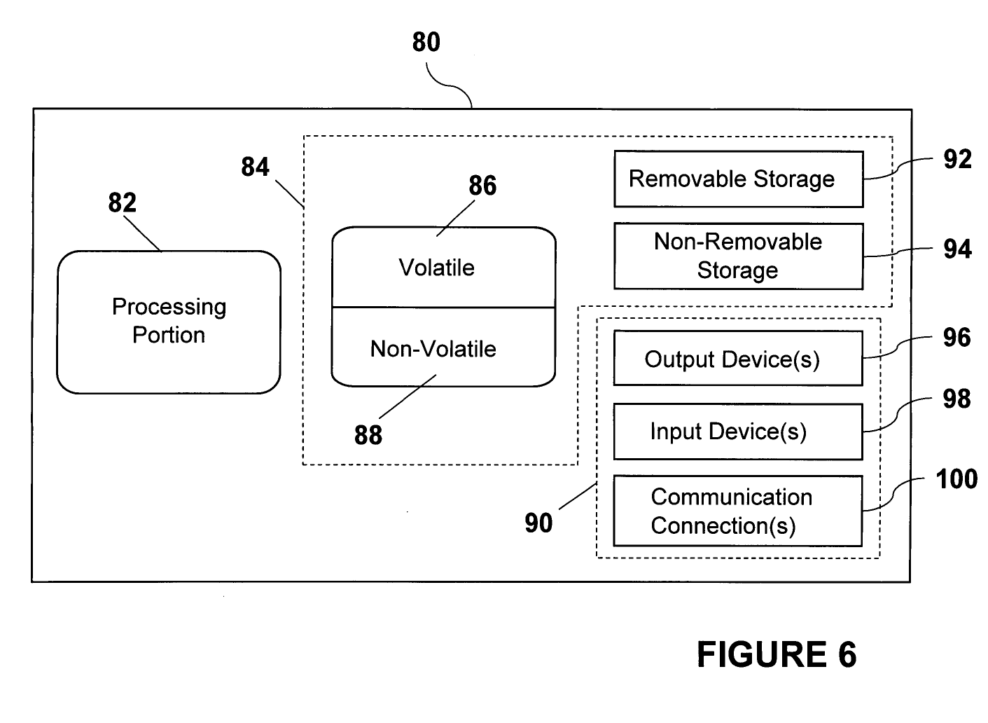

FIG. 6 is a diagram of an exemplary processor 80 for implementing public-key authentication. Processor 80 is representative of each of the user processor 92, the agent processor 94, and the merchant processor 78. The processor 80 comprises a processing portion 82, a memory portion 84, and an input/output portion 90. The processing portion 82, memory portion 84, and input/output portion 90 are coupled together (coupling not shown in FIG. 1) to allow communications therebetween. The processing portion 82 is capable of generating public-key cryptographic keys as described above. The processing portion 82 also is capable of signing (encrypting) information/data (e.g., the public key, optional information) with the private key. The memory portion 84 is capable of storing all parameters described above, such as the private key, the public key, and any additional information, for example.

The input/output portion 90 is capable of providing and/or receiving the components described above utilized to implement public-key authentication. The input/output portion 90 is capable of providing and/or receiving a declaration of adoption of a public-key authentication system. The input/output portion 90 is capable of providing and/or receiving the public key. The input/output portion 90 is capable of providing and/or receiving the request to establish an account based on public-key authentication. The input/output portion 90 is capable of providing and/or receiving notification that the account is one of authorized and not authorized. The input/output portion 90 is capable of providing and/or receiving a disclaimer of liability resulting from a transaction conducted based on fact based authentication. And, the input/output portion 90 is capable of providing and/or receiving the signed public key.

The processor 80 can be implemented as a client processor and/or a server processor. In a basic configuration, the processor 80 can include at least one processing portion 82 and memory portion 84. Depending upon the exact configuration and type of processor, the memory portion 84 can be volatile (such as RAM) 86, non-volatile (such as ROM, flash memory, etc.) 88, or a combination thereof. The processor 80 can have additional features/functionality. For example, the processor 80 can include additional storage (removable storage 92 and/or non-removable storage 94) including, but not limited to, magnetic or optical disks, tape, flash, smart cards or a combination thereof. Computer storage media, such as memory portion 84, 86, 88, 92, and 94, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 80. Any such computer storage media can be part of the processor 80.

The processor 80 can also contain communications connection(s) 100 that allow the processor 80 to communicate with other devices. Communications connection(s) 100 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. The processor 80 also can have input device(s) 98 such as keyboard, mouse, pen, voice input device, touch input device, etc. Output device(s) 96 such as a display, speakers, printer, etc. also can be included.

The various techniques described herein can be implemented in connection with hardware or software or, where appropriate, with a combination of both. Thus, the methods and apparatuses for using public-key authentication or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for indexing and searching numeric ranges. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language can be a compiled or interpreted language, and combined with hardware implementations. The methods and apparatuses for implementing public-key authentication also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing public-key authentication. When implemented on a general-purpose processor, the program code combines with the processor to provide a unique apparatus that operates to invoke the functionality of public-key authentication. Additionally, any storage techniques used in connection with public-key authentication can invariably be a combination of hardware and software.

While implementing public-key authentication has been described in connection with the exemplary embodiments of the various figures, it is to be understood that other similar embodiments can be used or modifications and additions can be made to the described embodiments for performing the same functions of using public-key authentication without deviating therefrom. Therefore, implementing public-key authentication as described herein should not be limited to any single embodiment, but rather should be construed in breadth and scope in accordance with the appended claims.

1. An authentication method comprising:
providing a declaration of adoption of public-key authentication for account creation;
providing a public key of a public key-private key cryptographic key pair;
requesting to establish an account based on said public-key authentication, wherein at least a portion of said request is signed with a private of said key pair;
receiving notification that said account is one of authorized and not authorized; and
providing a disclaimer of liability resulting from a transaction conducted based on fact based authentication.

2. (canceled)

3. A method in accordance with claim 1 wherein said act of requesting comprises providing said public key signed utilizing said private key.

4. A method in accordance with claim 1, wherein:
said declaration and said public key are provided to a first entity; and
said act of requesting is performed to establish an account with a second entity.

5. A method in accordance with claim 5, wherein:
said first entity comprises a credit bureau; and
said second entity comprises a merchant.

6. A method in accordance with claim 1, further comprising in person authentication of a requester requesting to establish said account.

7. An authentication method comprising:
receiving a declaration of adoption of public-key authentication;
receiving a public key of a public key-private key cryptographic key pair;
receiving a request to establish an account based on said public-key authentication,
wherein at least a portion of said request is signed utilizing a private key of said key pair,
determining an authenticity of said request;
providing a notification that said account is one of authorized and not authorized; and
receiving a disclaimer of liability resulting from a transaction conducted based on fact based authentication.

8. A method in accordance with claim 7, further comprising:
receiving a request to establish an alternate account based on personally identifiable information;
receiving an exception request authenticated by said key-pair, said exception request comprising permission to establish said alternate account, wherein permission to establish said alternate account is limited to a predetermined amount of time;
verifying an authenticity of said request to establish said alternate account utilizing said key pair and said authenticated exception request; and
providing a notification that said alternate account is one of authorized and not authorized.

9. (canceled)

10. A method in accordance with claim 7 wherein said request to establish an account comprises providing said public key signed utilizing said private key.

11. A method in accordance with claim 7, wherein:
said declaration and said public key are received by a first entity; and
said request to establish said account is with a second entity.

12. A method in accordance with claim 11, wherein:
said first entity comprises a credit bureau; and
said second entity comprises a merchant.

13. A method in accordance with claim 7, further comprising in person authentication of a requester requesting to establish said account.

14. A authentication system comprising
a processing portion for:
generating a public key-private key cryptographic key pair comprising a public key and a private key;
a memory portion for storing said public key and said private key; and
an input/output portion for:
providing a declaration of adoption of public-key authentication for account creation;
providing said public key of said public key-private key pair;
providing a request to establish, utilizing said private key of said key pair, an account based on said public-key authentication;
receiving notification that said account is one of authorized and not authorized; and
providing a disclaimer of liability resulting from a transaction conducted based on fact based authentication.

15. (canceled)

16. A system in accordance with claim 14, wherein:
said processor portion signs, utilizing said private key, said public key; and
said request to establish an account based on said public-key authentication comprises a signed request including said public key.

17. A system in accordance with claim 14, wherein:
said input/output portion provides said declaration and said public key to a first entity; and
said input/output portion provides request to establish an account based on said public-key authentication to a second entity.

18. A system in accordance with claim 17, wherein said first entity comprises a credit bureau.

19. A system in accordance with claim 17, wherein said second entity comprises a merchant.

20. A system in accordance with claim 14, wherein said memory portion comprises at least one of hard disk memory, flash memory, portable memory, a universal serial bus (USB) compatible memory, and smart card memory.
